(19) United States
(12) Patent Application Publication
(10) Pub. No.: US 2007/0085478 A1
(43) Pub. Date: Apr. 19, 2007

(54) High pressure alkali metal discharge lamp

(75) Inventors: James T. Dakin, Shaker Heights, OH (US); Jack M. Strok, Garrettsville, OH (US)

Correspondence Address: PEARNE & GORDON LLP, 1801 EAST 9TH STREET, SUITE 1200, CLEVELAND, OH, 44114-3108, US

(73) Assignee: General Electric Company

(21) Appl. No.: 11/249,985

(22) Filed: Oct. 13, 2005

(51) Int. Cl. H01J 61/12; H01J 61/20

(52) U.S. Cl. 313/571; 313/639

(57) ABSTRACT

A high pressure alkaline metal discharge lamp includes a ceramic arctube and a discharge-sustaining fill. The fill contains rare gas and alkali metal, the alkali metal being cesium, rubidium, potassium or mixtures thereof. The fill is mercury free and cadmium free. The alkali metal vapor pressure during operation is at least 2 atmospheres.

### FIELD OF THE INVENTION

The invention relates generally to high pressure discharge lamps and more particularly to a mercury-free high pressure alkali metal discharge lamp.

### DESCRIPTION OF RELATED ART

High pressure metal halide discharge lamps are well known in the art. These lamps produce good to excellent color depending on whether they utilize a quartz or ceramic arctube. These conventional metal halide lamps all rely on mercury vapor to provide the electrical properties suitable for impedance matching with lamp ballasts. However, for environmental reasons, it is desirable to eliminate the mercury from the fill material.

At present, there are discharge lamps without mercury in the arctube fill material. For example, high pressure sodium discharge lamps without mercury in the fill material are known to the art. However, these mercury-free high pressure sodium discharge lamps do not have the color rendering properties of the metal halide lamps. In contrast, electrodeless mercury-free lamps dosed with metal halides and metal halide salts require a large power supply, for which no practical source is available. Other mercury-free discharge lamps have utilized zinc or sulfur in the fill material, but these lamps are unsuccessful for other reasons.

### SUMMARY OF THE INVENTION

A high pressure alkali metal discharge lamp comprises a sealed light-transmissive envelope, a ceramic arctube positioned within the envelope, the arctube having a pair of spaced-apart electrodes and containing a discharge-sustaining fill. The fill contains rare gas and alkaline metal. The alkaline metal is selected from the group consisting of potassium, rubidium, cesium and mixtures thereof. The fill in the lamp is not more than 0.1 weight percent mercury and not more than 0.01 weight percent cadmium, the weight percents being based on the total weight of metal in the fill. The lamp has an alkali metal vapor pressure during operation of at least two atmospheres.

### BRIEF DESCRIPTION OF THE DRAWINGS

FIG. 1 illustrates in partially schematic form a high pressure discharge lamp according to the invention.

### DETAILED DESCRIPTION OF THE PREFERRED EMBODIMENTS OF THE INVENTION

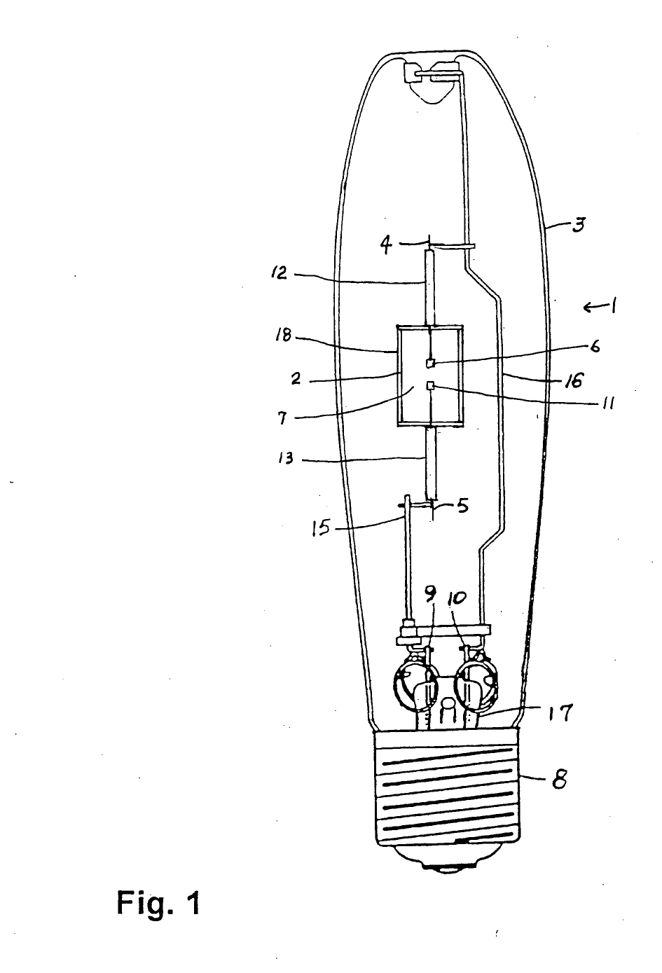

In the description that follows, when a preferred range, such as 5 to 25 (or 5-25) is given, this means preferably at least 5, and, separately and independently, preferably not more than 25. With reference to FIG. 1, there is shown a high pressure discharge lamp 1 comprising a ceramic arctube 2 disposed within a transparent glass or vitreous envelope 3. Arctube 2 comprises an arctube main body 18 (which defines an arc chamber containing fill 7), a first ceramic leg 12, a second ceramic leg 13, and a pair of electrodes 6, 11, which extend from their respective ceramic legs into the arc chamber. Electrically conductive lead wires 4, 5 are electrically connected to electrodes 6, 11 and to electrically conductive support members 16, 15, which are electrically connected to the threaded screw base 8 by inlead wires 10, 9, which extend through stem 17. In operation, the electrodes 6, 11 produce an arc which ionizes the fill 7 to produce a plasma in the arc chamber, inside the main body 18 of arctube 2.

The ceramic arctube 2 is preferably polycrystalline alumina (PCA) as known in the art. The electrodes in the arctube are typical three component (niobium-molybdenum-tungsten) ceramic metal halide (CMH) electrodes as known in the art, or alternatively niobium-tungsten without the molybdenum. The fill or fill material 7 in the arc chamber of the mail body 18 of the arctube 2 contains alkali metal and rare gas and preferably nothing else. The rare gas is preferably argon, less preferably krypton, less preferably xenon or neon, or a mixture of the foregoing. The alkali metal is preferably cesium, less preferably rubidium, less preferably potassium, or a mixture thereof. The fill is preferably free from the presence of, or free from the presence of a material or significant or effective amount of, halogen, mercury, cadmium, sulfur, zinc, oxygen, and other materials. The fill preferably has not more than 0.1 or 0.04 or 0.01 weight percent mercury and not more than 0.01 or 0.004 or 0.001 weight percent cadmium, said weight percents being based on the total weight of metal in the fill.

The rare gas is preferably present in the fill at a pressure of 0.01 to 1, more preferably 0.02-0.2, atm at 25° C., that is, before the lamp is energized. The alkali metal vapor pressure during operation of the lamp, i.e. after the lamp is energized and hot, is preferably 2-50, more preferably 2-20 or 3-19 or 4-18 or 5-17 or 6-16 or 8-13 or 9-11 or about 10, atmospheres, and preferably high enough to provide an arctube voltage greater than 50V.

The gap between the two electrodes is preferably 0.5-100 or 1-20 or 1-6, mm. The power or wattage or nominal wattage of the lamp is preferably 50-1000, more preferably 100-800, more preferably 200-500, more preferably 300-500, more preferably about 400, watts. The voltage or nominal voltage is preferably 50-200, more preferably 75-150, volts. The side wall thickness and end wall thickness of the arctube main body 18 is preferably 0.5-2, more preferably 0.8-1.5, more preferably about 1, mm. The external body wall loading is preferably 0.05-0.5, more preferably 0.1-0.3, more preferably 0.15-0.25, more preferably 0.15-0.2, W/mm². The lumens per watt is preferably greater than 50 or 60 or 70 or 80 or 90 lumens per watt. The arctube main body 18 has an external aspect ratio L/D of preferably 0.5-3, more preferably 1-2. The main body 18 is preferably cylindrical, less preferably ellipsoidal, and preferably has an outside diameter of 4-30 or 5-25 mm and preferably has an outside length of 5-40 or 7-35 mm and preferably has an internal diameter of 4-20 mm and preferably has an internal length of 5-30 mm. The ratio of the arc gap to the internal diameter is preferably 0.05-1.3 or 0.1-1 or 0.2-0.6; preferably the gap is less than the arctube internal diameter but high enough to provide arctube voltage greater than 30V. The electrode insertion is preferably 1-15 mm. Regarding the ceramic arctube legs 12 and 13, the external diameter is preferably 1-6 or 2-5 mm, the internal diameter is preferably 0.4-3 or 1-2 mm, the leg aspect ratio of length/diameter is preferably 2-10 or 3-8 and the leg length is preferably 7-30 or 10-25 mm.

Regarding lamp color, the Ra is preferably greater than 80, more preferably greater than 90 and the CCT is preferably 3000-6000 K, more preferably 3000-4000 K. The lamp is operable on a conventional low frequency, 50 Hz to 1 kHz, ballast, which is nonpulsed, that is, the power is supplied continuously to the electrodes, not pulsed.

Tungsten electrodes tend to have a desirably low work function in the presence of cesium vapor and thus offer excellent lumen maintenance and long life. When cesium fill is at the desired high operating pressure and power density, the visible part of the spectrum is filled with broadband quasi-molecular and non-resonance radiation with a near black body spectrum characteristic of an arc temperature in the 5000-6000 K range. Also, the infrared part of the spectrum is empty due to strong self-absorption by the cesium resonance lines. Thus, the color rendition of the cesium is in the good to excellent range. Similarly, the high arc temperature enhances the non-resonance line emission in the visible. Rubidium and potassium have similar discharge characteristics.

For example, a lamp could be provided with a cesium and argon fill and the following characteristics in a cylindrical PCA ceramic arctube lamp: 400 W, 0.2 W/mm² external body wall loading, 1.5 external aspect L/D ratio, 17.8 mm OD, 26.8 mm OL (outside length), 1.5 mm side and end wall thickness, 14.8 mm ID, 23.8 mm IL (internal length), 0.3 arc gap to internal diameter ratio, 4.45 mm arc gap, and 9.7 mm electrode insertion. Also for example, a lamp could be provided with a cesium and argon fill and the following characteristics in a cylindrical PCA ceramic arctube lamp: 100 W, 0.25 W/mm² external body wall loading, 1.2 external aspect L/D ratio, 8.7 mm OD, 10.4 mm OL (outside length), 0.8 mm side and end wall thickness, 7.1 mm ID, 8.8 mm IL (internal length), 0.3 arc gap to internal diameter ratio, 2.12 mm arc gap, and 3.3 mm electrode insertion.

The cold spot temperature at an operating pressure of about 10 atm of cesium is preferably about 1026° C. or 1000-1050° C. The cold spot temperature at an operating pressure of about 10 atm of potassium is preferably about 1113° C. or 1075-1150° C.

While specific embodiments of the invention have been described and illustrated, it is to be understood that these embodiments are provided by way of example only and that the invention is not to be construed as being limited thereto but only by proper scope of the following claims.

What is claimed is:

1. A high pressure alkali metal discharge lamp comprising a sealed light-transmissive envelope, a ceramic arctube positioned within said envelope, said arctube having a pair of spaced-apart electrodes and containing a discharge-sustaining fill, said fill containing rare gas and alkali metal, said alkali metal being selected from the group consisting of potassium, rubidium, cesium and mixtures thereof, the fill in said lamp being not more than 0.1 weight percent mercury and not more than 0.01 weight percent cadmium, said weight percents being based on the total weight of metal in the fill, the lamp having an alkali metal vapor pressure during operation of at least 2 atm.

2. The lamp of claim 1, wherein said fill consists essentially of rare gas and alkali metal.

3. The lamp of claim 2, wherein said alkali metal is cesium.

4. The lamp of claim 2, said lamp having a wattage during operation of 50-1000 W.

5. The lamp of claim 2, the lamp having a wattage during operation of 100-800 W.

6. The lamp of claim 3, the lamp having a cesium vapor pressure during operation of 2-20 atm.

7. The lamp of claim 6, the lamp having an external body wall loading during operation of 0.05 to 0.5 W/mm².

8. The lamp of claim 6, said lamp having an Ra greater than 80.

9. The lamp of claim 2, said arctube having a main body, said main body having an external aspect ratio of length to diameter of 0.5 to 3.

10. The lamp of claim 2, said lamp having an arc gap between said electrodes, said arctube having a main body having an internal diameter, the ratio of said arc gap to the internal diameter of said main body being 0.05 to 1.3.
